(19) United States
(12) Patent Application Publication
(10) Pub. No.: US 2012/0174551 A1
(43) Pub. Date: Jul. 12, 2012

(54) LAWN MOWER CLEANING AND MULCHING DEVICE AND METHOD

(76) Inventor: Randolph J. Hayward, Troy, NY (US)

(21) Appl. No.: 13/004,227

(22) Filed: Jan. 11, 2011

(51) Int. Cl. A01D 34/73; B23P 11/00; A01D 34/00

(52) U.S. Cl. 56/17.5; 56/255; 29/428

(57) ABSTRACT

Disclosed herein is a device for use with a lawn mower having a cutting blade, said device comprising: at least flexible monofilament line; and an attachment element for attaching the at least one flexible monofilament line to the lawn mower such that the at least one flexible monofilament line rotates during rotation of the cutting blade.

### FIELD

The subject matter disclosed herein relates generally to the field of lawn mowers. More particularly, the subject matter relates to a device for cleaning the under-belly of a lawnmower deck and mulching grass during use of the lawnmower, and method of use thereof.

### BACKGROUND

A lawnmower is a hand-operated or power-operated machine with rotary blades for cutting grass on lawns. Lawn mowers have been used to clip grass both residentially and commercially since their invention in the early 1800's. Most lawn mowers today are rotary mowers meaning that they employ a blade that rotates about a vertical axis. However, some cylinder or reel mowers employing a blade assembly that rotates about a horizontal axis are also well known in the art.

To make the process of cutting grass easier over the ages, many individuals have added onto the original design to add speed, efficiency, and power. It has also been found desirable to have lawn mowers mulch grass that has been cut so that finer grass clippings are left behind. Grass clippings that are mulched in this way will be less likely to mat together and suffocate the lawn underneath, thereby preventing the need to remove the grass clippings. In addition, grass clippings can also stimulate growth by fertilizing, retaining moisture, reducing erosion, suppressing weed growth and germinating seeds in the existing lawn.

One undesirable even that often occurs when cutting lawns is when grass clumps up and sticks to the under belly of the deck of the lawn mower. This may occur, for example, when the grass to be cut is moist, or when the grass to be cut is particularly thick. When this occurs, the efficiency of the lawn mower may be significantly reduced, and the speed at which grass can be mowed without the engine stalling may also be reduced. Furthermore, in these situations, the underbelly of the deck of the lawnmower must be cleaned so that the grass clippings do not permanently harden.

In light of this background, a lawn mower cleaning and mulching device and method would be well received in the art.

### BRIEF DESCRIPTION

According to one aspect, a device for use with a lawn mower having a cutting blade comprises: at least one flexible monofilament line; and an attachment element for attaching the at least one flexible monofilament line to the lawn mower such that the at least one flexible monofilament line rotates during rotation of the cutting blade.

According to another aspect, a cutting blade for use with a lawn mower comprising: a blade having: a base, a leading edge for cutting grass; and a trailing edge on the side opposite the side for cutting grass; and a solid flexible member attached to the blade for rotation with the blade.

According to another aspect, a lawn mower comprises: a deck; a plurality of wheels attached to the deck; a motor, attached to the deck, said motor having a rotor extending therefrom; a blade, attached to the rotor, said blade having a base, a leading edge for cutting grass; and a trailing edge on the side opposite the side for cutting grass; and a solid flexible member attached to the blade for rotation with the blade.

According to another aspect, a device for use with a lawn mower comprises: a flexible elongated member; and means for attaching the elongated flexible member such that the flexible member rotates with a blade of the lawn mower and extends upwards toward an underbelly of the lawn mower.

According to yet another aspect, a method comprises: attaching a device to at least one of: a rotor of a lawn mower; and a blade of a lawn mower; rotating the device through the rotor of a blade of the lawnmower; and contacting an underbelly of the lawn mower with the device during rotation of the rotor.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts an perspective view of a lawn mower cleaning and mulching device, in accordance with one embodiment;

FIG. 2 depicts a perspective view of the lawn mower cleaning and mulching device of FIG. 1 attached to a lawn mower, in accordance with one embodiment;

FIG. 3 depicts a perspective view of a the lawn mower in use cutting a lawn, in accordance with one embodiment;

FIG. 4 depicts a perspective view of a lawn mower cleaning and mulching device, in accordance with another embodiment;

FIG. 5 depicts a perspective view of a lawn mower cleaning and mulching device, in accordance with another embodiment;

FIG. 6 depicts a perspective view of a lawn mower cleaning and mulching device, in accordance with another embodiment;

FIG. 7 depicts a side view of the lawn mower cleaning and mulching device of FIG. 6;

FIG. 8 depicts a perspective view of a lawn mower cleaning and mulching device similar to the lawn mower cleaning and mulching device of FIGS. 6-7, but having a different attachment element in accordance with another embodiment;

FIG. 9 depicts a side view of the lawn mower cleaning and mulching device of FIG. 8 taken at arrows 9-9;

FIG. 10 depicts a perspective view of a lawn mower cleaning and mulching device, in accordance with another embodiment;

FIG. 11 depicts a side view of a lawn mower cleaning and mulching device, in accordance with another embodiment; and

FIG. 12 depicts a perspective view of a lawn mower cleaning and mulching device, in accordance with another embodiment.

### DETAILED DESCRIPTION

A detailed description of the hereinafter described embodiments of the disclosed apparatus and method are presented herein by way of exemplification and not limitation with reference to the Figures.

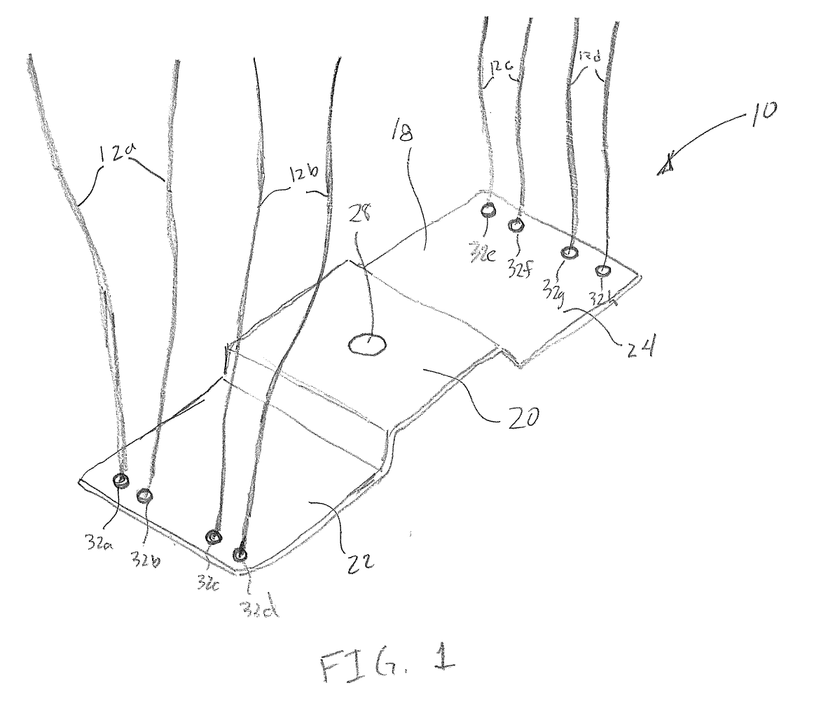

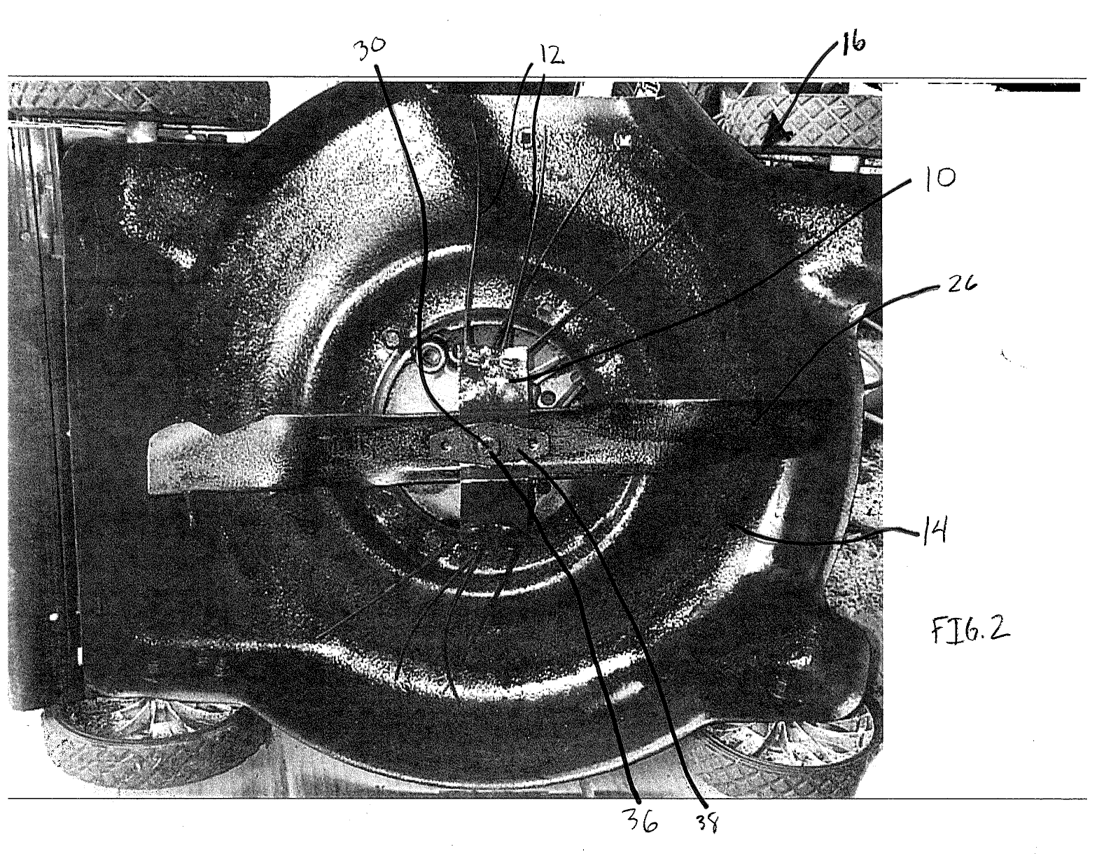

Referring to FIGS. 1-2, a lawn mower cleaning and mulching device 10 is shown. The lawn mower cleaning and mulching device 10 includes a plurality of elongated elements 12 that are configured to contact an underbelly 14 of a lawnmower 16 during operation of the lawnmower 16. The elongated elements 12 may be made of plastic, nylon, or the like. The elongated elements 12 may be flexible or semi flexible. However, the elongated elements 12 may comprise a rigidity and desire to retain its shape. This rigidity may help retain the elongated elements 12 in contact with the underbelly 14 of the lawnmower 16 during operation. The elongated elements 12 may be solid lengths of a flexible monofilament line used typically with a string trimmer, strimmer, line trimmer, Weedeater®, Weedwhacker®, weed whip, weedy, whipper snipper, garden trimmer, grass trimmer or trimmer, such as trimmer or weed wacking line, or any other type of nylon or plastic chord. Furthermore, the diameter of the elongated elements 12 or trimmer line may be any size, such as 065-155. The cross section of the elongated elements 12 or trimmer line may have a cross section of any shape such as circular, square, triangular, octagonal. It should be understood that the description of the elongated elements 12 may also be applied to the various other embodiments described herein.

The string trimmer of the present invention works on the principle that a line that is turned fast enough is held out from its housing very stiffly by centripetal force. The faster it turns the stiffer the line. Even round-section nylon line is able to mulch the cut grass and slight, woody plants quite well after it has been cut by the blade. Some monofilament lines, designed for more powerful cutters, may have an extruded shape—like a star—that helps the line slash the material being cut and thus it is able to cut quite large woody plants (small shrubs) or at least ring-bark them very effectively.

The motor turns the blade and the line extends horizontally. The operator controls the height at which cutting takes place of the blade and the trimmer line simultaneously by adjustment of the deck. As the line is worn, or breaks off, the operator replaces the line. The line can also have an ‘auto-feed’ operation (not shown) on a line attached to a reel. Newly extended line operates more efficiently because of its heavier weight and surface effects (the star-shaped edges).

The lawn mower cleaning and mulching device 10 may be thereby configured to clean the underbelly 14 of the lawnmower 16 so that grass does not stick and accumulate to the underbelly 14. Furthermore, the lawn mower cleaning and mulching device 10 may be configured to mulch the clipped grass into smaller lengths prior to the lawn mower 16 depositing the grass clippings back onto the ground.

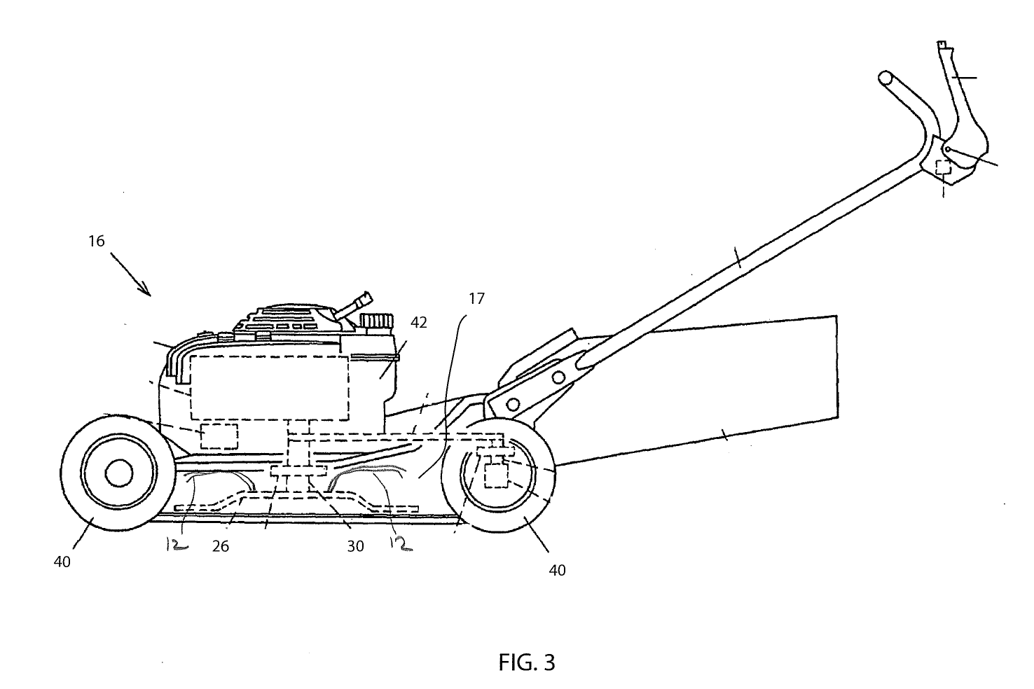

FIG. 3 shows the lawnmower 16 having a deck 17. A plurality of wheels 40 may be attachable to the deck 17. Furthermore, a motor 42 may be attachable to the deck having a rotor 30 extending therefrom and having a blade 26 that is turned by the rotor 30. While the lawnmower 16 shown in FIG. 3 depicts a typical residential push-style lawn mower, it should be understood that the lawn mower cleaning and mulching device 10 may be attachable to any lawn mower, both commercial and residential. For larger commercial embodiments having lawn mowers with larger underbellies, it will be apparent to one skilled in the art that the dimensions of the lawn mower cleaning and mulching device 10 may also be larger than the dimensions of the residential embodiment depicted in the Figures.

The lawn mower cleaning and mulching device 10 is shown having an attachment element 18, such as a base shown in FIGS. 1-2. The attachment element 18 may be made of a metal material such as aluminum, chromium, copper, iron, magnesium, nickel, titanium and zinc, or combinations thereof. Steels and stainless steels are also contemplated. Furthermore, the attachment element 18 may comprise a composite material or a plastic or the like. Any material that would be robust enough for implementation with the present invention and result in an appropriate product life is contemplated. Appropriate product life may range anywhere between an hour and hundreds of hours of use.

The attachment element 18 includes a raised portion 20 that is located between a left side 22 and a right side 24. The raised portion 20 may be configured to integrate with the cross section of the blade 26 of the lawnmower 16, as shown in FIG. 2. The attachment element 18 further includes an opening 28 in the raised portion 20 for installation to the rotor axis 30 of the lawn mower 16. It should be understood that the dimensions and profile of the attachment element 18 shown in the Figures is meant to be exemplary. Other embodiments are depicted where the attachment element 18 does not include a raised portion at all and may simply be flat. Alternately, the attachment element 18 may include a concave portion (not shown). The attachment element 18 may be fashioned with any profile that would accommodate integration with the rotor axis 30 of a lawn mower. It should be understood that the attachment element 18 may be attached to the rotor axis 30 either above the blade 26 (in between the blade 26 and the underbelly 14 of the lawnmower 16), or may be attached below the blade 26 (in between the blade 26 and the lawn that is being mowed).

The attachment element 18 is shown having four holes 32 on each of the left side 22 and the right side 24. The holes 32 may be aligned substantially equidistant the axis of rotation at the rotor 30 so that the elongated elements 12 are spread out across the underbelly 14. The holes 32 may be configured to each receive the elongated elements 12. While the holes 32 are shown to attach the elongated elements 12 to the attachment element 18, any other attachment means is contemplated such as a fastener, epoxy, or the like. It is also contemplated that the elongated elements 12 are an integral portion of the attachment element 18 rather than a separately attachable to the attachment element 18.

In the embodiment depicted, the holes 32 may be dimensioned so that the elongated elements 12 are insertable but retainable in position. A single elongated element 12 may be inserted into a first hole 32a, and then inserted into a second hole 32b. The proximity of the holes 32a and 32b with respect to each other, along with the mechanical rigidity of the elongated elements 12 may help to retain the elongated elements 12 in position. The embodiment shown includes four physical elongated elements 12a-12d even though there are eight holes 32a-32h and eight lengths extending from the holes. However, configuration is not limited to this, as any number of elongated elements and corresponding holes or other attachment devices are contemplated.

Whatever the embodiment, the elongated elements 12 may be configured to extend from the attachment element 18 in the direction of the raised portion 20 toward the underbelly 14 of the lawnmower 16. The elongated elements 12 may thus curve about the underbelly 14, making contact with the underbelly 14 across a substantial portion of their length. Thus, the elongated elements 12 may have a sufficient length to extend across at least a substantial portion of the radius of the underbelly 14 of the lawnmower. This aspect of the lawn mower cleaning and mulching device 10 may be facilitated by the flexible rigidity of the elongated elements 12, as described herein above.

The attachment element 18 of the lawn mower cleaning and mulching device 10 may be attachable to the rotor axis 30 the lawn mower 12 with a bolt 36 and a washer 38. The attachment element 18 may be attachable in a perpendicular manner with respect to the blade 26, as shown in the Figures. However, attachment element 18 may be attachable at any other angle relative to the blade 26. Furthermore, in the embodiment depicted, the attachment element 18 is attached below the blade 26. However, the attachment element 18 may also be configured to attach above the blade 26 of the lawn mower.

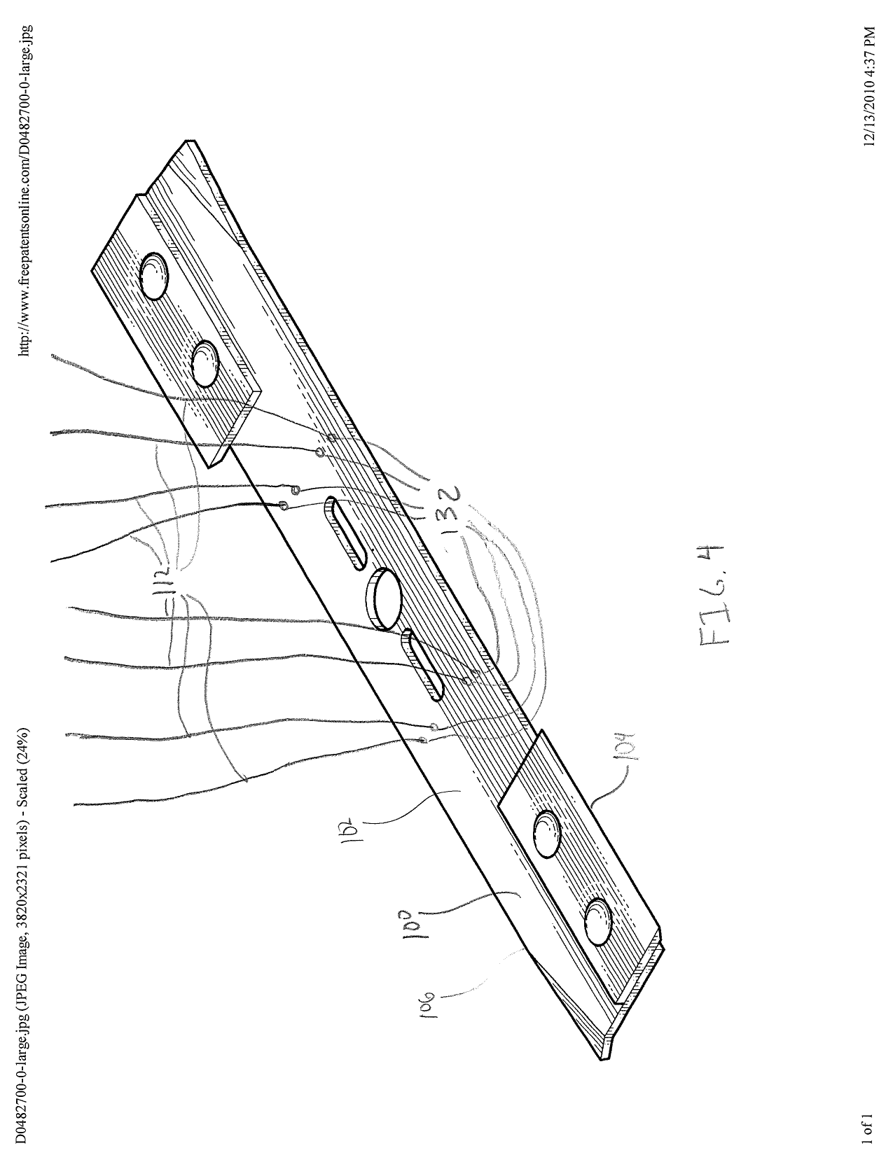

Referring now to FIG. 4, another embodiment is shown that includes a modified blade 100 attached to a lawn mower. The blade 100 may include a base 102, a leading edge 104 and a trailing edge 106. Rather than attaching a separate base attachment element to the lawn mower, the modified blade 100 may include several holes 132 for attachment to elongated elements 112. The hole 132 attachment elements may receive the elongated elements 112. The attachment element holes 132 may be aligned substantially equidistant about the axis of rotation of the modified blade 100 in a similar manner to the embodiment depicted in FIGS. 1-2. It should be understood that any lawn mower blade may be modified to include the holes 132 and the attached elongated elements 112, and that the particular blade 100 shown in FIG. 4 is not meant to be limiting.

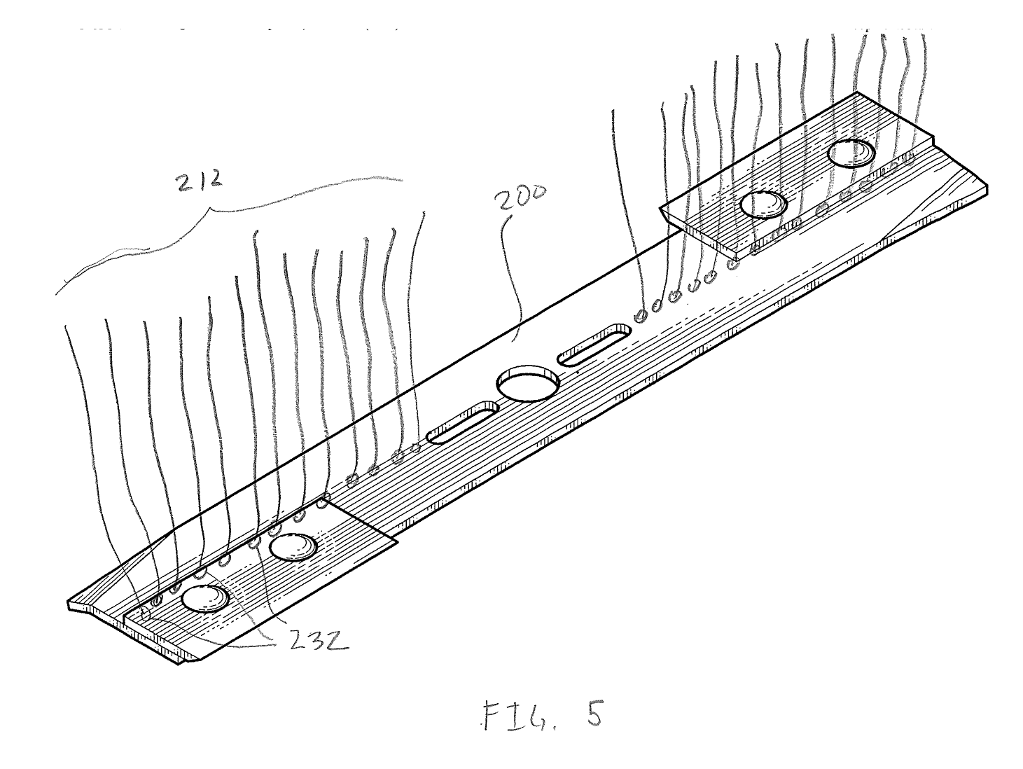

Alternately, in another embodiment depicted in FIG. 5, holes 232 may be applied to a blade 200 at any other location across the length of the blade. For example, rather than curving about an underbelly 114 of the lawn mower, the modified blade 200 may be configured with several elongated elements 212 that are each fashioned with a length that extends so that the elongated elements 212 contact the underbelly during operation of the lawn mower. For example, the elongated elements 112 may be attached along the trailing edge 106 of the blade 100. Alternately, the elongated elements 112 may be attached along the leading edge 104 of the blade.

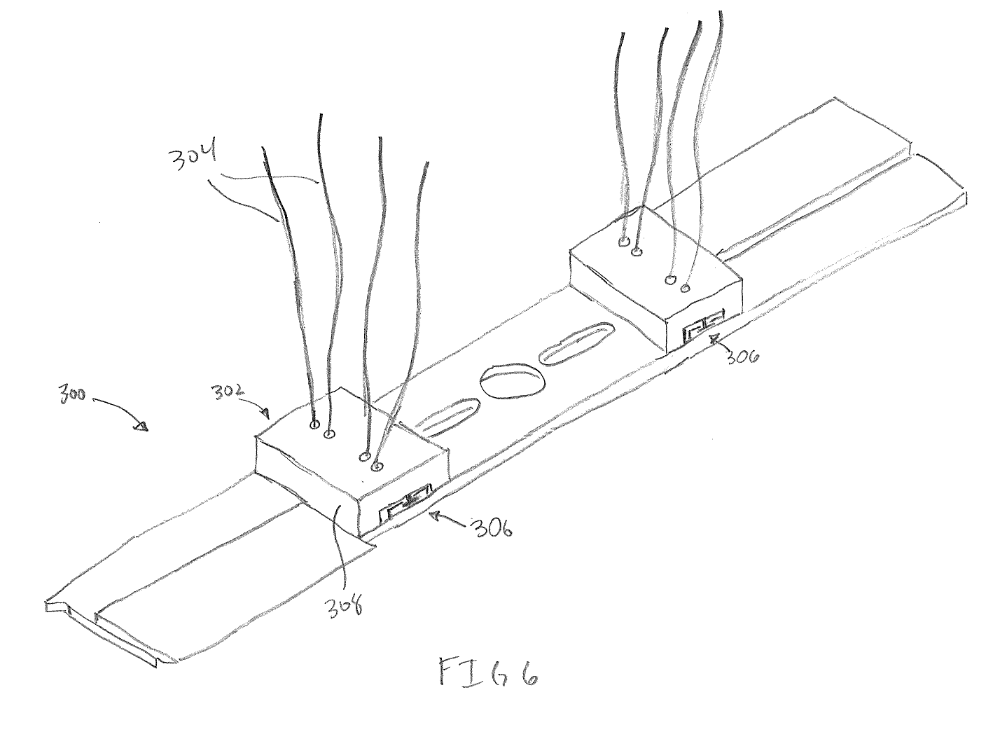

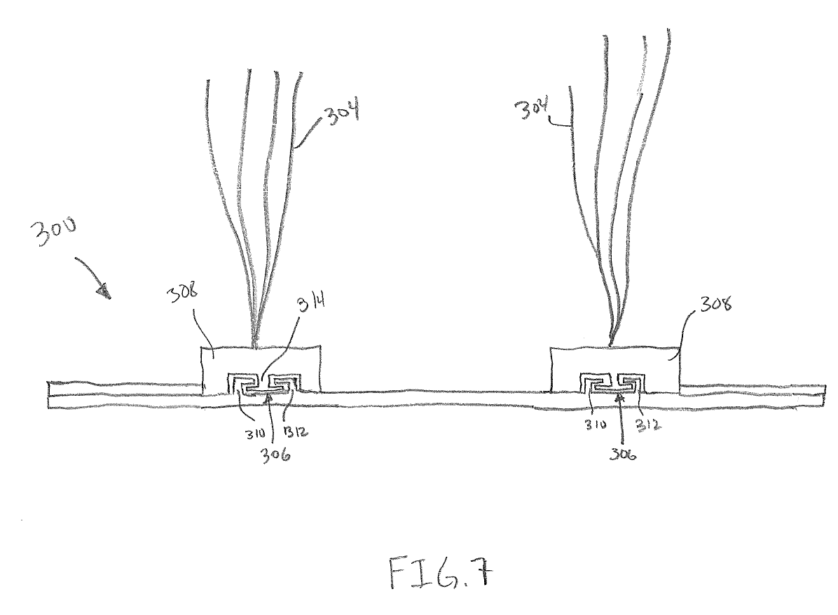

In another embodiment, shown in FIG. 6, a modified blade 300 may be specifically configured to receive and secure a separate component 302 having cleaning extension elements 304 attached thereto. For example, the modified blade 300 may include a receptacle, slot, or channel 306 for receiving a housing 308 that includes one or more of the elongated elements 304. FIG. 7 shows a side view of the slot for receiving the separate component 302 according to one embodiment. In this embodiment, the modified blade may include two opposing protrusions 310, 312 which comprise the channel The separate component 302 may include a T-shaped insertion element 314 for insertion into the channel 306. The housing 308 may, for example, be snapped into place but may also be easily removable and replaceable if the elongated elements become worn or reduced in length due to operation of a lawn mower, such as the lawn mower 16. The housing 308 may house additional length of the elongated elements 304 such that one may pull out the elongated element 304 from the housing 308 if additional length is needed, in the case that the elongated elements 304 are reduced in length.

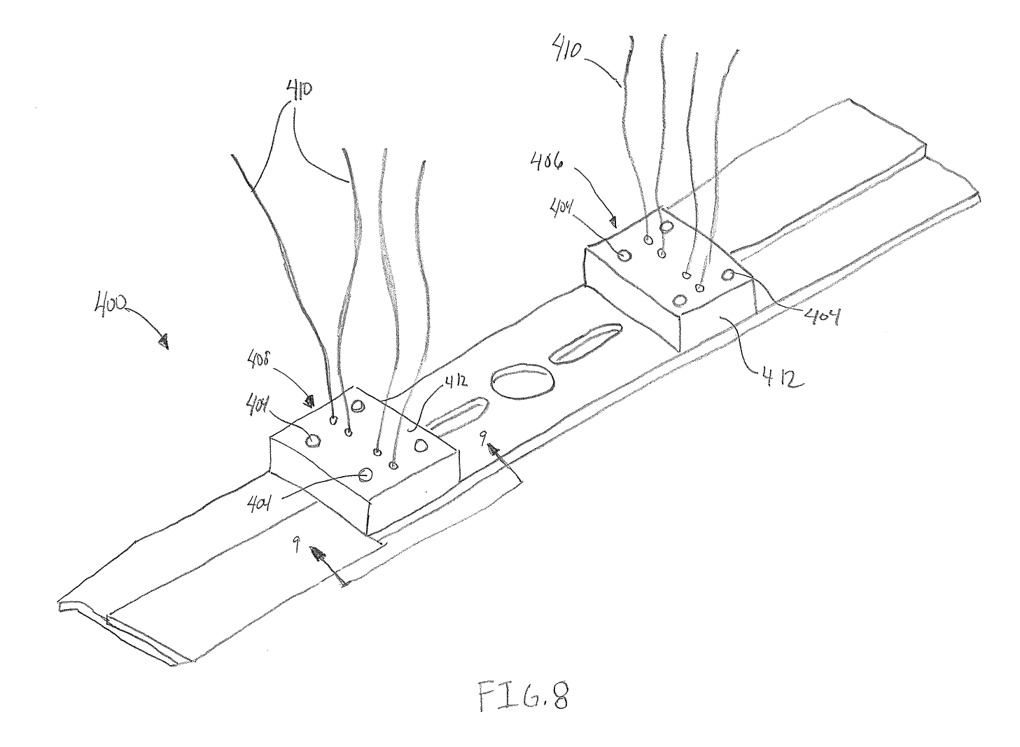

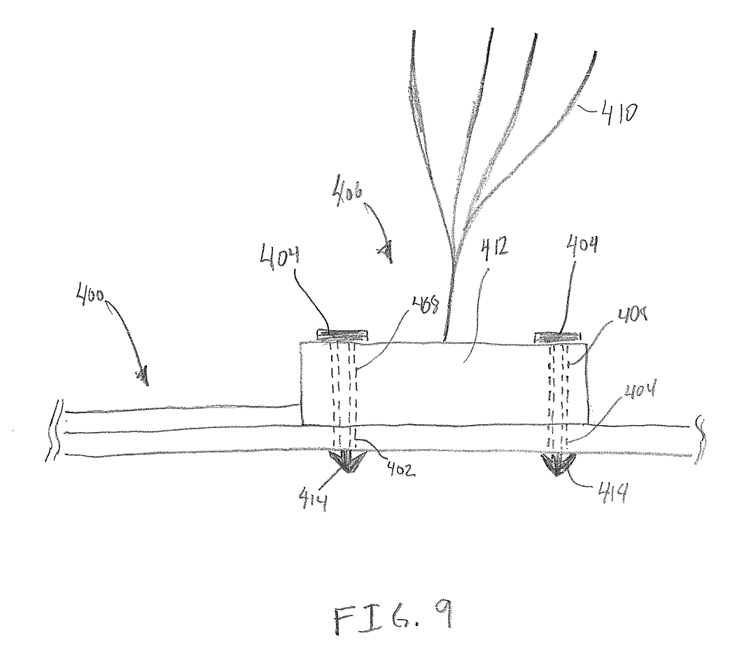

Shown in FIG. 8 is another modified blade 400 that is similar to the embodiment depicted in FIGS. 6-7. However, rather than having the opposing protrusions 310, 312 defining the channel 306, the modified blade 400 shown in FIG. 8 includes a plurality of holes 402. The holes 402 may be configured to accept a respective anchor pin 404. Furthermore, a separate component 406 similar to the separate component 302 may include corresponding holes 408. The anchor pins 404 may include a tapered or pointed end 414 that is configured compress during insertion into the holes 402, 408 and then expand once the anchor pin 404 is securely within the hole 402 such that the anchor pin 404 attaches the separate component 406 to the blade 400. FIG. 9 shows a side view of this connection. Similar to the previous embodiment, the separate component 406 may include one or more elongated elements 410 extending from a housing 412. The housing 412 may house additional length of the elongated elements 410 such that one may pull out the elongated element 410 from the housing 412 if additional length is needed, in the case that the elongated elements 410 are reduced in length.

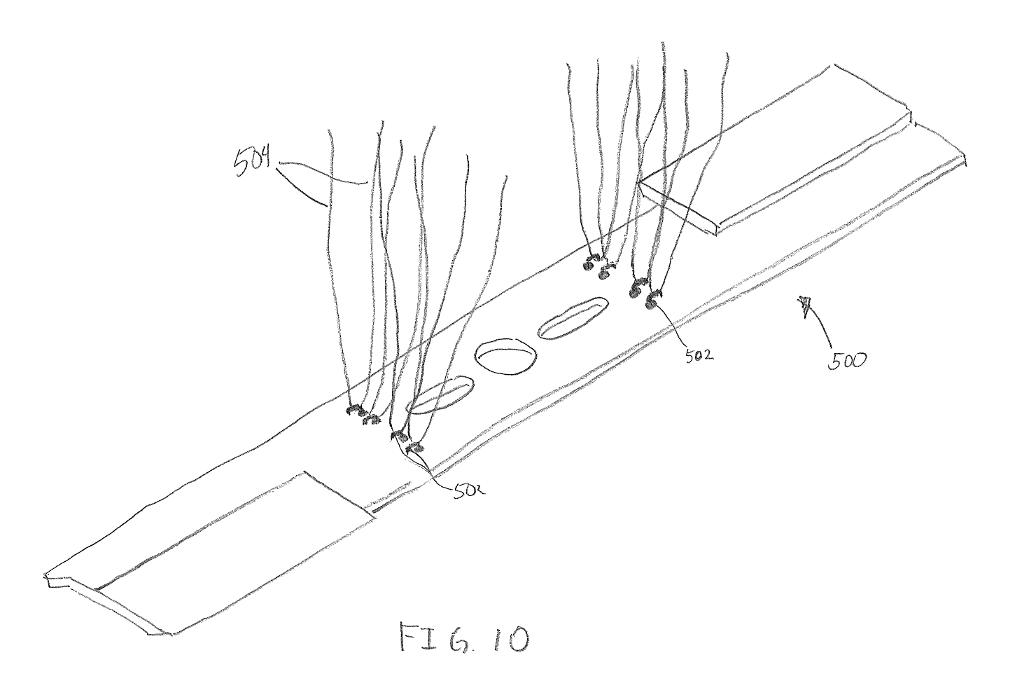

In another embodiment, shown in FIG. 10, a modified blade 500 may include a plurality of resiliently elastic tabs 502 as attachment elements. The tabs 502 may be another form of attachment element and may be configured to receive elongated elements 504. For example, the elongated elements 504 may be snapped into the resiliently elastic tabs 502 such they are retained during operation of a lawn mower. However, the elongated elements 504 may be removed from the tabs 502 by a user in order to replace the elongated elements 504.

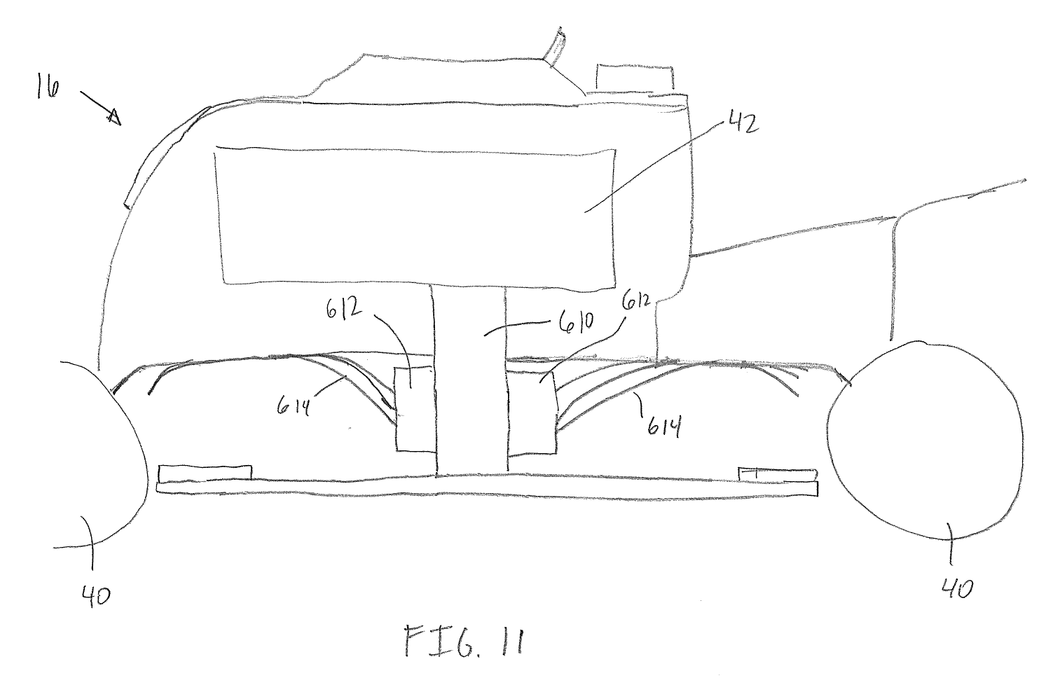

Further, in another embodiment shown in FIG. 11, a rotary axis 610 of the lawn mower may include an integrated housing 612 for one or more elongated elements 614. Rather than attaching a separate base portion, such as the base portion 18, a portion of the rotary axis 610 that is located above the blade of the mower may house lengths of elongated elements 614 that extend from the housing and contact the underbelly of the lawnmower in a similar manner to those described herein above. The integrated housing 612 itself may include an attachment element for holding the elongated elements 614 attached to the rotor. The attachment element may simply be that the elongated elements 614 are wrapped around the rotor internally within the housing. Additionally, the housing may include holes 616 having a substantially similar diameter as the elongated elements 614. The friction from these holes 616 may help retain the elongated elements 614 within the housing 612. Additionally, the housing 612 may include an internal component that retains the elongated elements 614 retained during operation.

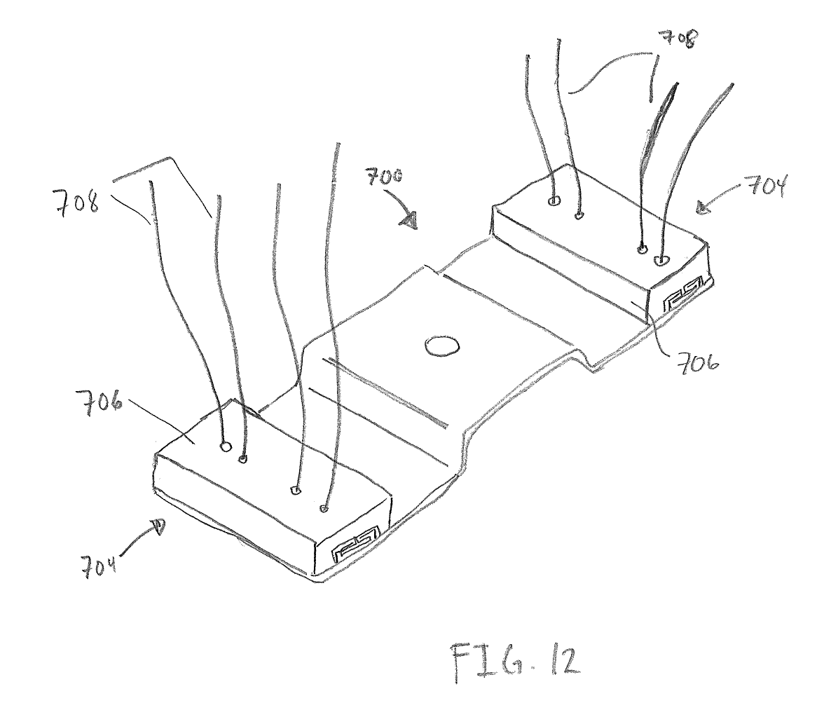

Referring now to FIG. 12, another embodiment of a lawn mower cleaning and mulching device is shown. This embodiment includes an attachment element 700 or base portion that is similar to the attachment element 18 depicted in FIGS. 1-2. However, in this embodiment, an attachment element 700 or base portion may include slots (not shown) similar to the slot or channels 306 for attachment to a separate component 704, similar to the separate component 302. Alternately, the attachment element 700 may include holes (not shown) for attachment with anchor pins, such as the embodiment depicted in FIGS. 8-9. In the embodiment depicted, for example, one separate component 704 may be attached to each side of the base portion attachment element 700. The separate component 704 may include a housing 706 having cleaning extension elements 708 attached thereto. It should be understood that the attachment element 700 may include more attachment locations for more separate components 704. For example, the base attachment element 700 may include four extending ends, and may be shaped like a cross. In this embodiment, the attachment element 700 may be configured to include four corresponding separate components 704. Any number of separate components 704 and elongated cleaning elements 708 are contemplated.

It should be understood that in the various embodiments described herein, the solid and flexible elongated elements may be attached to the rotor or blade of the lawn mower in such a way that they are angled upward toward the underbelly of the lawnmower. This contact between the elongated elements and the underbelly of the lawn mower may remain throughout operation of the lawnmower.

Furthermore, an embodiment contemplated includes a method of mowing grass. The method may include attaching a device to a lawn mower and rotating the device through rotation of a rotor of the lawnmower. The method may include attaching the device to at least one of a rotor of the lawnmower and a blade of the lawnmower. The method may then include contacting an underbelly of the lawn mower with the device during rotation of the rotor. Thus, the method may include cleaning the underbelly of the lawn mower with the device, and further include mulching the grass clippings to reduce the length of the clippings. Finally, the method may include unattaching the device or replacing the device when necessary.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A device for use with a lawn mower having a cutting blade, said device comprising:
at least flexible monofilament line; and
an attachment element for attaching the at least one flexible monofilament line to the lawn mower such that the at least one flexible monofilament line rotates during rotation of the cutting blade.

2. The device of claim 1, wherein the at least one flexible monofilament line is attached to the cutting blade.

3. The device of claim 1, wherein the at least one flexible monofilament line is attached to a rotor of the lawn mower.

4. The device of claim 1, wherein the attachment element for attaching the at least one trimmer line attaches the flexible elongated element at an angle toward an underbelly of the lawn mower for cleaning the lawn mower when the lawnmower is in use.

5. A cutting blade for use with a lawn mower comprising:
a blade having:
a base,
a leading edge for cutting grass; and
a trailing edge on the side opposite the side for cutting grass; and
a solid flexible member attached to the blade for rotation with the blade.

6. The device of claim 4, wherein the solid flexible member is attached to the blade.

7. The device of claim 5, wherein the solid flexible member is attached to a base removably attachable to the blade.

8. The device of claim 6, wherein the base is attached to a trailing edge of the blade.

9. The device of claim 6, wherein the base is attached to the blade through a rotor that turns the blade.

10. A lawn mower comprising:
a deck;
a plurality of wheels attached to the deck;
a motor, attached to the deck, said motor having a rotor extending therefrom;
a blade, attached to the rotor, said blade having
a base,
a leading edge for cutting grass; and
a trailing edge on the side opposite the side for cutting grass; and
a solid flexible member attached to the blade for rotation with the blade.

11. The device of claim 4, wherein the solid flexible member is attached to the blade.

12. The device of claim 5, wherein the solid flexible member is attached to a base removably attachable to the blade.

13. The device of claim 6, wherein the base is attached to a trailing edge of the blade.

14. The device of claim 6, wherein the base is attached to the blade through a rotor that turns the blade.

15. A device for use with a lawn mower comprising:
a flexible elongated member; and
means for attaching the elongated flexible member such that the flexible member rotates with a blade of the lawn mower and extends upwards toward an underbelly of the lawn mower.

16. A method comprising:
attaching a device to at least one of:
a rotor of a lawn mower; and
a blade of a lawn mower;
rotating the device through the rotor of a blade of the lawnmower; and
contacting an underbelly of the lawn mower with the device during rotation of the rotor.

17. The method of claim 16, further comprising cleaning the underbelly of the lawn mower with the device.

18. The method of claim 16, wherein the device includes an elongate element.

19. The method of claim 16, further comprising unattaching the device from at least one of:
the lawn mower; and
the blade of the lawn mower.

20. The method of claim 16, further comprising mulching grass clippings with the device.
